(19) United States
(12) Patent Application Publication
(10) Pub. No.: US 2005/0074537 A1
(43) Pub. Date: Apr. 7, 2005

(54) Sandwich sized chips

(76) Inventor: Benjamin L. Bakos, Riverside, IL (US)

Correspondence Address: David W. Okey;Brinks Hofer Gilson & Lione, P.O. Box 10395, Chicago, IL, 60610, US

(21) Appl. No.: 10/677,013

(22) Filed: Oct. 1, 2003

(51) Int. Cl. A23L 1/216

(52) U.S. Cl. 426/637

(57) ABSTRACT

A sandwich sized vegetable chip, at least about eight square inches, is placed between slices of bread, along with other sandwich ingredients, to add crunchiness and enjoyment to consumption of a sandwich. The very large chip, such as a potato chip or a corn chip, is made by a special process that keeps the chip from assuming the usual “saddle” shape of potato chips. Besides potato chips, corn chips may be made from a similar special process, so that the corn chips or other vegetable chips assume a generally planar shape and are at least about 2 inches wide by about 4 inches long, although other shapes and sizes may also be used.

### FIELD OF THE INVENTION

The technical field is that of foods and food processing, and in particular the formation of foods made from vegetables, such as corn and potatoes, and the processing of such foods.

### BACKGROUND

Many Americans enjoy snack foods, such as potato chips and corn chips. These foods are popular for several reasons, including their taste, their convenience, and their association with recreation and youth. Snack foods such as these are purchased in a ready-to-eat form, and are also packaged in a number of ways so as to further enhance convenience to the user. As an example, a consumer may purchase a half-pound or more of potato chips at a supermarket, ready to take home for consumption by a family. A consumer may also purchase these chips, however, in quantities of about an ounce, just the right amount for consumption at a single meal, such as a luncheon meal. Lunch with such a food may be consumed at school, at the workplace, or when the consumer is in transit. Chips are made and packaged with convenience in mind.

Another reason chips are popular is that they are fun to eat and have a delicious taste and feel. Consumers enjoy foods that may be eaten with a satisfying crunch. This may be the reason for the popularity of crunchy, tasty snack foods such as cookies, crackers, chips, pretzels, and nuts. The crispness and the satisfying crunch of these foods, such as potato chips or corn chips, is hard to duplicate. It is sufficiently enjoyable that people would like to enjoy the crunch and the taste in other foods.

It has been noted that some people enjoy potato chips or corn chips in a sandwich—not with their sandwich, but inside the sandwich, between the outer layers of bread. In an interview reported by the Rocky Mountain News, Denver, Colo., on Jun. 28, 2003, a consumer noted that one of her habits is that “whenever I make a sandwich I always have to put chips in there . . . I really like the taste and crunch.” Of course, a disadvantage of adding chips to a sandwich is that chips tend to be small, much smaller, for instance, than the slices of bread that typically are included in a sandwich. Therefore, when people add chips to a sandwich, the process can be messy and inconvenient. What is needed is a better chip that people can add to a sandwich with convenience and a

### BRIEF SUMMARY

One aspect of the invention is a method for making a substantially planar potato chip in a shape of a slice of bread having a minimum size of eight square inches, about 2 inches by about 4 inches. The method comprises providing a potato dough, adding at least one additive to the potatoes, grinding a mixture of potatoes and the at least one additive, extruding the mixture into a thin sheet, cutting the thin sheet into chips, and frying the chips.

Another aspect of the invention is a method for making a substantially planar corn chip in a shape of a slice of bread having a minimum size of about 2 inches by about 4 inches. The method comprises providing a corn flour dough and adding at least one additive to the dough, drying the dough, extruding the dough into a thin sheet, cutting the sheet into pieces, and frying the chips.

Another aspect of the invention is a sandwich-sized vegetable chip. The chip comprises a substantially planar vegetable chip in a shape of a slice of bread having a minimum size of about 2 inches by about 4 inches or about eight square inches. These and many other aspects of the invention will become apparent from the drawings the description following.

### BRIEF DESCRIPTION OF THE DRAWINGS

FIGS. 1a-1e are embodiments of a sandwich-sized vegetable chip;

FIGS. 2a-2d are perforated embodiments of a sandwich-sized vegetable chip;

FIG. 3 is a flowchart for a process for making sandwich-sized potato chips;

FIG. 4 is a flowchart for an alternate process for making sandwich-sized potato chips;

FIG. 5 is a flowchart for a process for making sandwich sized corn chips;

FIG. 6 is a flow chart for an alternate process for making sandwich sized corn chips; and

FIG. 7 is an apparatus for frying sandwich sized chips.

### DETAILED DESCRIPTION OF THE DRAWINGS AND THE PRESENTLY PREFERRED EMBODIMENTS

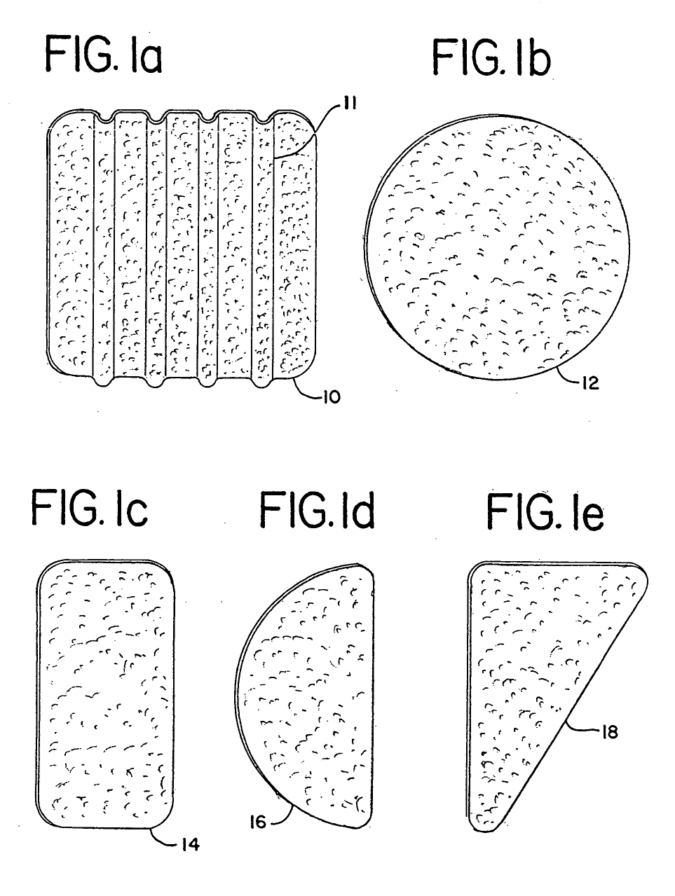

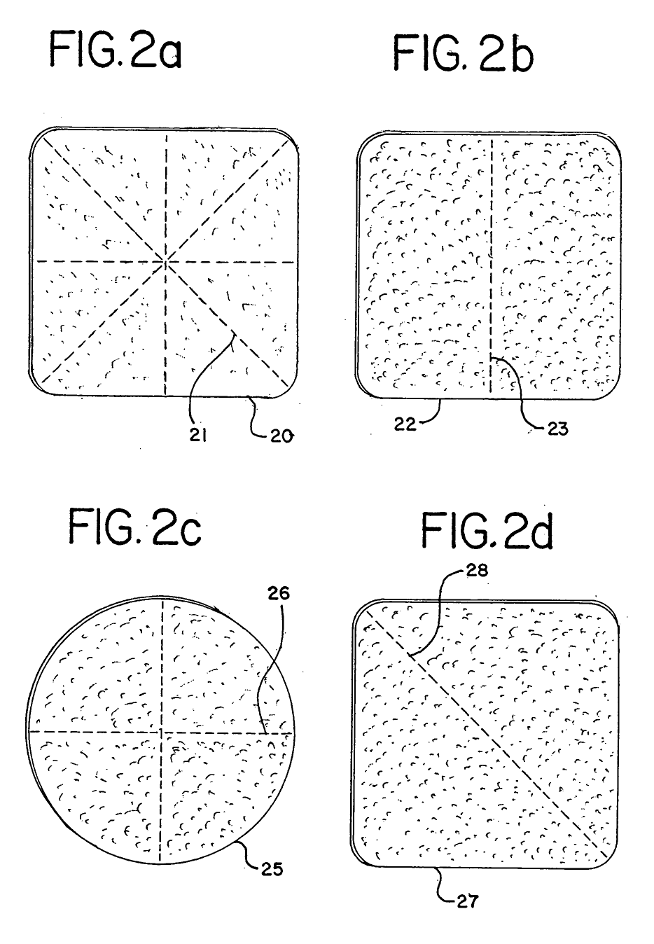

Embodiments of the invention are depicted in FIGS. 1a-1e and 2a-2d. FIG. 1a depicts a sandwich-sized potato chip 10 in the form of a square or a rectangle about the size of a slice of bread, from about 4 to 4.5 inches wide to about 4 to 4.5 inches high. The chip may have ridges or raised portions 11 on one or both sides of the chip. The corners are rounded, preferably with a large corner radius, perhaps from about 0.125 to about 0.25 inches, although a different corner radius may be used.

Typical slices of bread have dimensions of about 4 inches in height by about 4.5 inches in width. Therefore, in these embodiments, a vegetable chip may be about 2 to 2¼ inches in width and about 4 to 5 inches in height, for a half-sandwich size. The chips may be about 4 to 5 inches in height by about 4 to 5 inches wide for a full-sandwich size. The term “sandwich-sized” refers to a chip that is about half the size of a slice of bread to about the size of a full slice of bread. As will be seen, embodiments are not limited to squares or rectangles.

FIG. 1b depicts a second embodiment of a sandwich sized corn chip 12, in a circular shape, such as would be used, for example, on a sandwich made from a Kaiser roll. The chip may be from about 4 inches to 5 or 6 inches in diameter. FIG. 1c depicts a sandwich sized chip 14 in the shape of a rounded rectangle. In one embodiment, a chip of this shape may have dimensions of about 2 or 2.25 inches width and 4 to 4.5 inches of height. In another embodiment, the chip may be up to about 3 inches wide and about 6 inches long, in the shape of a rounded rectangle for a “submarine” or “hero” sandwich. FIG. 1d depicts a sandwich-sized chip 16 in the form of a half-circle, with a radius of about 2 to 2.25 inches. FIG. 1e depicts a sandwich-sized chip 18 in the form of a rounded triangle, as would be expected if one cut a sandwich on the bias. The chip would be about 4 to 4.5 inches at its widest point and would be about 4 to 5 inches in height.

Chips according to the present invention may also be made with perforations. The perforations desirably extend at least about one-quarter to one-half way through the chip. The perforations will aid in the cooking process, allowing moisture to evaporate and separate from the chip. The perforations also make it easier to separate a portion of a chip after processing has been completed. FIG. 2a depicts a corn chip 20 in the form of a full slice of bread. The chip is prepared with perforations 21 that may make it easier to separate half of the chip, with perhaps further separations into a quarter-chip or one-eighth of a chip. FIG. 2b depicts a potato chip 22 in a similar square or rectangular shape, with a single perforation 23 down its center, for separation into two halves, each suitable for insertion into half a sandwich. The perforations on the chip may even be used as a guide or ruler to aid in cutting the sandwich evenly.

FIG. 2c depicts a vegetable chip 25 in the shape of a circle or ellipse 25 with perforations 26 that allow easy separation into a half-circle or half-ellipse. This chip may have a diameter of from about 4 to 4.5 inches to about 5 inches. This shape may be suitable for sandwiches made from a loaf of bread that assumes a more rounded shape, such as pumpernickels or certain rye breads. FIG. 2d depicts a potato chip 27 in the form of a rectangle with a perforation 28 on the bias. The perforation allows for easy separation into two triangle-shaped portions, suitable for a sandwich that is also cut on the bias. Perforations may be placed as desired on the chip, but preferably extend from one edge or corner on a chip to an opposite end or corner, so that a portion of the chip may easily be separated.

The chips may be prepared by any means usually used to prepare vegetable chips, such as corn chips or potato chips. As is well known in the art, potato chips may be prepared from potatoes by a process that includes washing, peeling, slicing, drying and cooking the chips in oil. However, most potatoes are not as large in cross-section as a typical slice of bread, and thus the size of a sandwich or even a half of a sandwich. Therefore, a more elaborate method is used to prepare sandwich-sized potato chips. This also applies to corn chips, since kernels of corn are even smaller.

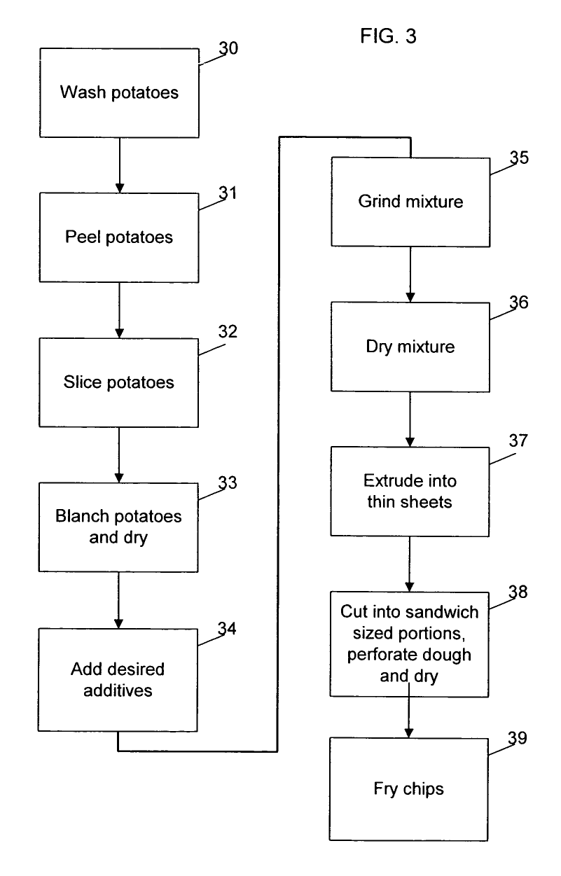

The methods used to prepare sandwich-sized vegetable chips will thus require formation of a dough, such as potato dough or corn dough from which sandwich-sized potato chips or corn chips may be prepared. FIG. 3 is one embodiment of a process for making very large, sandwich sized potato chips. A first step in the process is to wash potatoes 30 and peel the potatoes 31. The potatoes will then be sliced 32, and then blanched and dried 33. In one embodiment, the potatoes are sliced about a quarter-inch thick and the blanching takes place by contacting the slices with steam for about 2-3 minutes, at a temperature of up to 200° F. The sliced potatoes may then be dried by placing in an oven and air drying at about 200° F. By this point, the dried potatoes desirably have a moisture content of about 40%.

Additives may now be made 34 to the dried potatoes for enhancing the flavor or texture of the resulting large potato chip products. These additives may include salts and color additives. These additives may include seasoning or flavors, including, but not limited to, nacho cheese, cool ranch, barbeque, Cajun, onion, sour cream, salsa, and dill pickle. The additives may also include potato flakes, dextrose, sucrose, corn syrup or other additives as desired. The dried potatoes are then ground 35 together and mixed thoroughly. The grinder preferably uses a grinding plate with holes about 1/16″ in diameter in order to achieve the proper consistency in the ground mixture. The mixture is then dried 36 if necessary

The resulting potato dough is then fed to an extruder and extruded 37 into thin sheets, desirably from about 0.10 to about 0.20 inches thick, although thicker or thinner extrudate may also be made. The extrudate may then be processed through a diecutter or other cutting process for separation 38 into individual sandwich-sized portions. The die cutter may have dies suitable for two kinds of cuts, a longer die portion for separation into individual portions, and a shorter portion for adding the perforations, as shown in FIGS. 2a-2d. The perforations may extend half-way through the dough, or may extend nearly all the way through, so long as the perforations do not hinder the dough processing by causing separation. The perforations desirably extend about one-quarter to about one-half way through the dough. Processing with other perforation parameters may also be used, or a separate die or roller for the perforations may also be used.

At this point in the processing, the cut portions may be further held for an additional drying step 38 if necessary. The chips are then fried 39, and are then cooled and packed as desired. The chips may be fried in vegetable oil at a temperature from about 175° C. to about 205° C. for about 15-60 seconds.

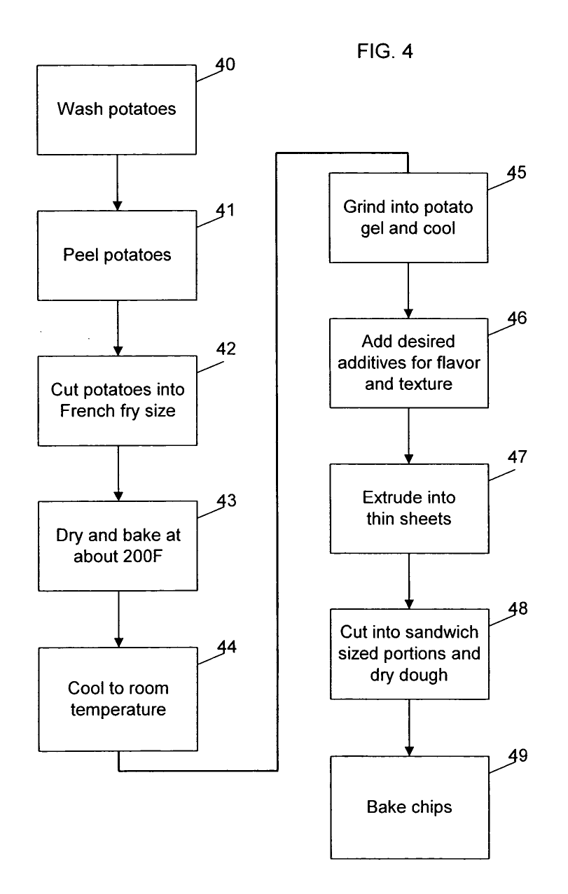

Another process for making potato dough and sandwich-sized potato chips is disclosed in FIG. 4. In this process, a first step is to wash potatoes 41, followed by peeling the potatoes, and then cutting 42 them into about French fry size. The potatoes are then dried and baked 43 for about a half hour at about 200° F. until the moisture content of the potatoes is about 50-55%. The dried potatoes are then cooled 44 to room temperature, ground into a potato gel and cooled 45. Additives may now be added 46, in order to enhance the flavor, texture, and “mouth” feel of the resulting chips. These additives may include potato flakes or granules, wheat starch, corn syrup, sugars such as dextrose or sucrose, and water if necessary. Emulsifiers may be helpful in ensuring the consistency of the mixture. Salt, flavors, seasoning and coloring may also be added to improve the flavor and appearance of the chips.

The potato dough that results is then extruded 47 into thin sheets and cut 48 into sandwich-sized portions for further processing. The dough may first be dried if desired, until the dough moisture content is below about 45%. At this point, the chips may be baked 49 or cooked as desired. In one embodiment of a baking process, the chips are baked at a temperature from 300 to about 450° F. (149 to 232° C.). If the dough is fried instead of baked, the frying time may be from about 15 to about 30 seconds, and may use vegetable oil at about 170° C. to about 180° C. Other time and temperature regimes may also be used.

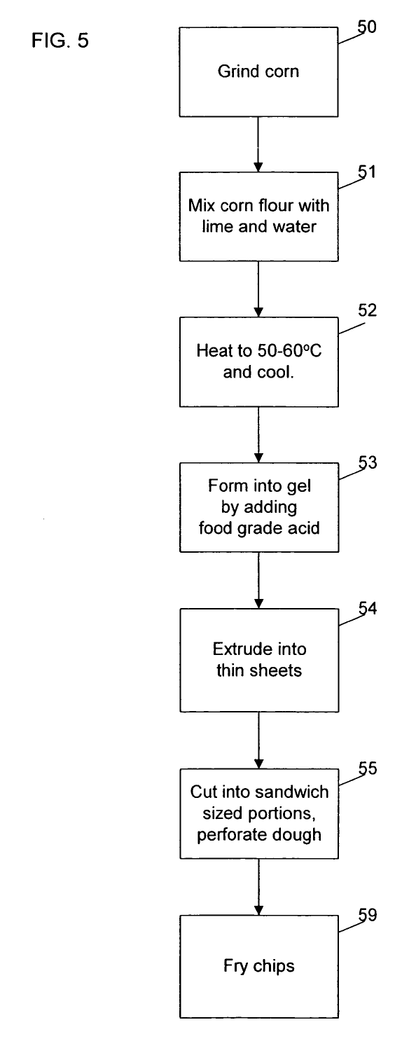

While the above examples have dealt with potato chips that are made sandwich-size, other vegetables or grains may also be used in making large snack chips. These vegetable include oats and corn. FIG. 5 is a flowchart for a method of making sandwich-sized corn chips. The first step 50 is to grind corn or to obtain ground corn or masa. The corn masa is then mixed 51 with food-grade calcium hydroxide (lime) and water and heated 52 to about 50-60° C. before cooling. About 0.1 to about 0.3 wt % of lime is sufficient to adjust the pH of the mixture and to enhance the flavor of the resulting chips. Corn masa is generally steeped for a number of hours, such as at least six to twelve hours, before further processing.

At this point, additives may be added 53 to the mixture. Salts, color agents such as food dyes, seasoning, and flavorings may also be added. These include any flavor additives, such as those mentioned earlier, nacho cheese, cool ranch, barbeque, Cajun, onion, sour cream, salsa, and dill pickle. The mixture may also be made into a gel for easier processing by adding about 0.25% to about 0.4% by weight food-grade acid, such as fumaric acid, phosphoric acid, citric acid, ascorbic acid, and the like. The mixture is then cooled and extruded 54 into thin sheets, about 0.1 to about 0.15 inches thick. The extrudate is then cut 55 into sandwich sized portions and the dough may be perforated. The corn chips may be fried in vegetable oil at a temperature of from about 175° C. to about 250° C. for a period of time from about 15 to about 30 seconds. Alternatively, the corn chips may be baked in an oven at a temperature from 400 to 500° F. (204 to 260° C.).

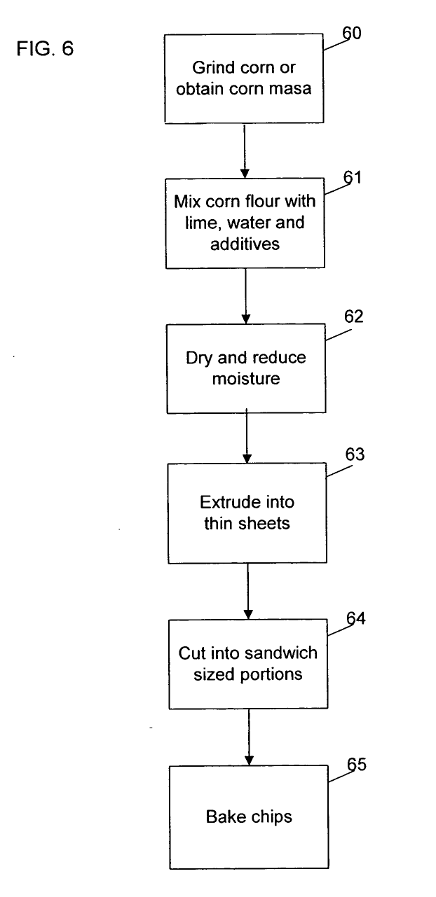

An alternative process for making sandwich-sized corn chips is disclosed in FIG. 6. A first step is to grind corn 60 or to obtain corn masa or corn flour. The corn flour may then be mixed 61 with lime and water, and any additives that are desired to enhance the flavor or texture of the resulting chips. Flavor additives may include any desired flavor, such as the flavors mentioned earlier. The mixture is then dried 62 until moisture is reduced to below about 45-55%. The resulting mixture is then extruded 63 into a thin sheet and cut 64 into sandwich sized portions, allowing for shrinkage during cooking. The dough is then baked 65 in an oven at a temperature from 400 to 500° F. (204 to 260° C.). Batch ovens may be used to bake the chips. Alternatively, a tunnel oven, in which the chips are continuously conveyed in a heated tunnel while baking, may also be used.

If it is desired to fry the chips in vegetable oil, a frying time for a period of from about 150° C. to about 230° C. is desirable. Other temperatures and times may be used. As noted above, the chips may be baked instead of fried, in order to reduce the amount of oil in the finished chips.

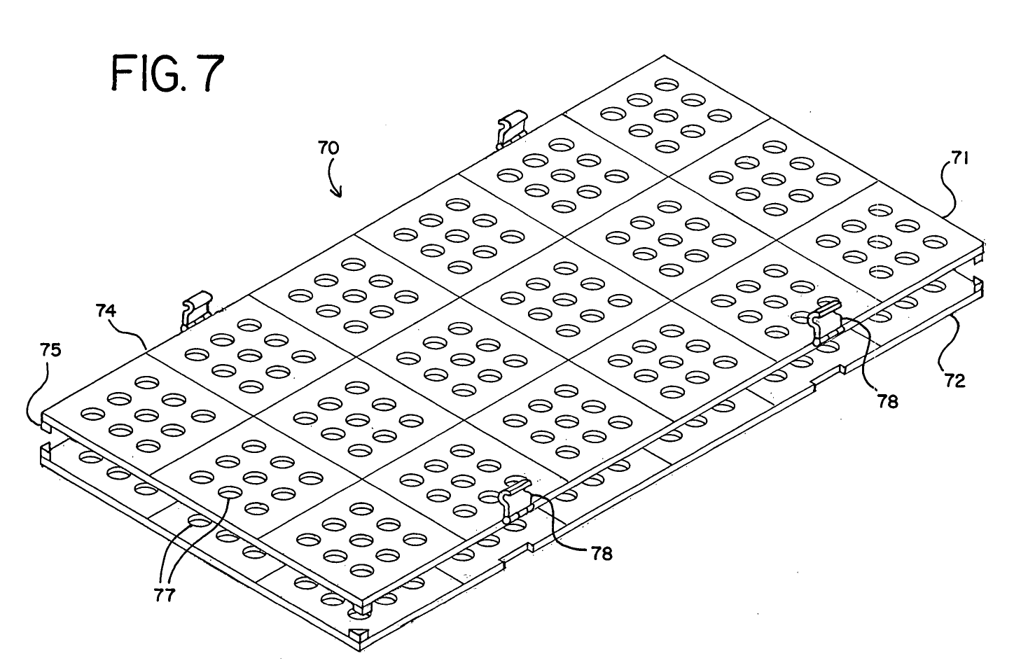

In order to ensure that the sandwich-sized chips keep roughly in a planar shape during frying, it may be helpful, as noted above, to cut the dough into a size and shape commensurate with the chip that is desired at the end of the process. It may also be helpful to “mold” the dough during the frying process with an apparatus or frying utensil as depicted in FIG. 7. The utensil 70 is a wire rack which is divided into a plurality of compartments, each compartment meant to hold a single cut piece of dough for a sandwich-sized chip or snack. The wire rack has a top half 71 and a bottom half 72. Each half is divided into compartments by longitudinal wires 74 and cross wires 73. These wires may comprise one wire or more for each border with the next compartment, such that the dough from one compartment cannot leave the compartment during frying. The halves may mate with fittings 75 designed for specific desired separation of the halves. Closures 78 keep the wire rack together during the frying process.

Fittings 75 are designed so that there is a specified separation between the halves, just sufficient so that when the dough is placed into wire rack 70, the top and bottom halves 71, 72 close and touch the dough without compressing the dough. With this fit, the wire rack halves encourage the dough to remain relatively flat during the frying or baking operation. With a rack of this design, the resulting chips do not tend to “oilcan” or “potato chip” during cooking, thus avoiding the traditional saddle shape of a potato chip or other snack, such as curled or curly-cued corn chips.

It should be understood that sandwich sized vegetable chips are not limited to only potato or corn chips. The advantages of the present invention may also be embodied in chips made from wheat flour, bran flour, barley flour, oat flour and many other grains and vegetables, or combinations of grains and vegetables. It is also understood that grains or vegetable besides the primary grain or vegetable may also be used in any particular embodiment. For instance, in the process depicted in FIG. 4 for making sandwich-size potato chips, wheat starch and corn syrup are used, even though the end-product is potato chips. Thus, grains, cereals, or vegetable may mixed as desired in making a sandwich-sized vegetable chip. Oat bran or oat flour may also be used in potato chips, or may be used to make an oat chip. All these variations and embodiments are meant to be included within the scope of the invention.

Chips made according to the present invention find favor with consumers who enjoy the combination of a crunchy chip with their sandwich. The chips may be packaged in stacks of chips and sold to consumers for home (and sack lunch) use. The packages are desirably re-sealable or at least re-closable in order to retain freshness and keep out moisture. It is also possible to package each chip individually or as part of a pre-packaged lunch, meant for sale at a deli or supermarket. By taking measures to keep the chips fresh, they will retain their crunch when placed in a sandwich and consumed. Packaging will be important to sandwich-sized chips. They are fragile, combining a relatively large size with very little thickness, although not as fragile as ordinary potato chips. Suggested packaging is from about 4 oz. to about 8 oz. packages, although larger or smaller packages may also be used.

The details of the various elements of the processes not otherwise disclosed are not believed to be critical to the achievement of the advantages of the present invention, so long as the grain or vegetable selected has a desirable taste and mouth “feel” after appropriate processing. The selection of such details is believed to be well within the ability of one of even rudimentary skills in this area, in view of the present disclosure, and are within the spirit of the invention and the scope of the claims. It will be understood that no limitation of the scope of the invention is intended by the above description and drawings, which is defined by the claims below. For instance, when chips are baked rather than fried, the resulting baked chips tend to be drier and less flavorful than when they are fried. In these cases, a small amount of oil, preferably about five to ten weight percent of oil, preferably mixed with flavorings, may be sprayed onto the resulting chips to enhance flavor before the chips are cooled and packaged.

The chip embodiments of the present invention are described as generally in the shape of a slice of bread. This shape includes shapes that are not generally sliced into multiple slices, such as the bread for a submarine sandwich, while is typically sliced lengthwise only once, yielding two roughly rounded rectangular slices, which are by definition in the shape of a slice of bread. The shape of a slice of bread is also meant to include a half slice of bread, as when a sandwich or a slice of bread is cut in half length-wise or width-wise, as demonstrated by the perforations in FIG. 2b, or on the bias, as shown in FIG. 1e and by the perforations in FIG. 2d.

It is intended that the vegetable chips of the present invention are not limited to the preferred embodiments described above. Very large potatoes, for instance, may be thinly sliced and fried or baked to yield sandwich-sized potato chips, although the process may be more costly and the quantity of suitable potatoes less than may be desired. All these are intended as embodiments of the invention.

It is intended that the foregoing detailed description be regarded as illustrative rather than limiting. Accordingly, it is the intention of the applicant to protect all variations and modifications within the valid scope of the present invention. It is intended that the invention be defined by the following claims, including all equivalents. Since the foregoing detailed description has described only a few of the many alternative forms this invention can take, it is intended that only the following claims, including all equivalents, be regarded as a definition of this invention.

1. A vegetable chip, comprising:
a substantially planar vegetable chip in a shape of a slice of bread having a minimum size of about eight square inches.

2. The vegetable chip of claim 1 wherein the chip is a potato chip or a corn chip.

3. The vegetable chip of claim 1, further comprising at least one of a salt, a flavor additive, a color additive, and a seasoning.

4. The vegetable chip of claim 1, wherein the chip is from about 0.025 to about 0.10 inches thick.

5. The vegetable chip of claim 1, further comprising at least one row of perforations extending from about one edge or corner to an opposite edge or corner.

6. The vegetable chip of claim 1, wherein the oil content is from about two percent to about forty percent.

7. A method for making a substantially planar potato chip in a shape of a slice of bread having a minimum size of about eight square inches, the method comprising:
providing a potato dough;
adding at least one additive to the dough;
grinding a mixture of the dough and the at least one additive;
extruding the mixture into a thin sheet;
cutting the thin sheet into portions; and
cooking the portions into chips.

8. The method of claim 7, further comprising a step of slicing potatoes about one-quarter inch thick to form the potato dough.

9. The method of claim 7, further comprising steps of washing potatoes, peeling the potatoes, slicing the potatoes, blanching and drying the potatoes.

10. The method of claim 9, wherein the step of drying the potatoes further comprises heating the potatoes.

11. The method of claim 10, further comprising cooling the potatoes after the step of heating.

12. The method of claim 7, wherein the step of grinding results in formation of a gel.

13. The method of claim 7, wherein the thin sheets are cut into portions via die-cutting.

14. The method of claim 7, wherein the portions are cooked in a rack that keeps the chips substantially planar.

15. The method of claim 7, further comprising perforating the dough after the step of extruding.

16. The method of claim 7, wherein the step of adding adds a flavor additive, a color additive, and a seasoning.

17. The method of claim 7, further comprising spraying a mixture of oil and at least one of salt, flavorings, seasonings and colorants onto the chips after the step of cooking the chips.

18. The method of claim 7, wherein the step of cooking comprises frying or baking the chips.

19. A method for making a substantially planar corn chip having a minimum size of about eight square inches in a shape of a slice of bread, the method comprising:
providing a corn flour dough;
adding at least one additive to the dough;
drying the dough;
extruding the dough into a thin sheet;
cutting the sheet into pieces; and
cooking the chips.

20. The method of claim 19, wherein the at least one additive is salt.

21. The method of claim 19, further comprising heating the dough and cooling the dough after the step of mixing.

22. The method of claim 19, further comprising adding a food grade acid after the step of drying to form a gel.

23. The method of claim 19, further comprising perforating the dough after the step of extruding the dough.

24. The method of claim 19, further comprising adding a flavoring or a salt after the step of drying.

25. The method of claim 19, further comprising spraying a mixture of oil and at least one of salt, flavorings, seasonings and colorants onto the chips after the step of cooking the chips.
